(19) United States
(12) Patent Application Publication
(10) Pub. No.: US 2021/0121964 A1
(43) Pub. Date: Apr. 29, 2021

(54) Preparation and Use of Silver Alloy Composite Nanomaterial

(71) Applicant: Wen Cao, Shenzhen (CN)

(72) Inventor: Wen Cao, Shenzhen (CN)

(21) Appl. No.: 17/136,291

(22) Filed: Dec. 29, 2020

Related U.S. Application Data
(62) Division of application No. 16/133,448, filed on Sep. 17, 2018.

(30) Foreign Application Priority Data
Sep. 15, 2017 (CN) 201710834160.X

(51) Int. Cl. B22F 9/12; B22F 1/00; B22F 9/14; A41D 31/00; A63B 71/12; C22C 1/04

(52) U.S. Cl. CPC B22F 9/12; B22F 1/0018; B22F 9/14; A41D 31/00; A63B 71/1225; A41D 31/30; A63B 2209/00; B22F 2301/255; B22F 2304/054; A41D 2500/00; C22C 1/0466

(57) ABSTRACT

The present disclosure provides a method of preparing a silver alloy composite nanomaterial. The preparation method comprises forming a silver alloy comprising at least one of copper, zinc, magnesium, aluminum and titanium into a composite metal rod; evaporating the silver alloy of the composite metal rod, resulting in a gaseous alloy; rapidly cooling the gaseous alloy so as to condense the silver alloy into a solid state; and collecting the cooled powder so as to obtain the silver alloy composite nanomaterial.

### CROSS-REFERENCE TO RELATED APPLICATIONS

This application is a division of U.S. patent application Ser. No. 16/133,448, filed on Sep. 17, 2018, and entitled “Preparation and Use of Silver Alloy Composite Nanomaterial”, which claims the benefit of Chinese Patent Application No. 201710834160.X, filed on Sep. 15, 2017 and entitled “Preparation Method of Silver Alloy Composite Nanomaterial,” of which each application is incorporated by reference herein in its entirety and for all purposes.

### FIELD

The present disclosure relates to the field of nanomaterials, and in particular relates to silver alloy nanomaterials.

### BACKGROUND

Silver is widely deemed as a safe and reliable bactericidal material. The bactericidal effect of nano-silver cannot be replicated by other inorganic materials. However, there are different levels of technical barriers in the production of nano-silver, as well as in the promotion and application of nano-silver in various industries.

At present, most nano-silver is produced by chemical methods. However, nano-silver produced by such methods is present in the reaction solution, and separation of the nano-silver from the liquid in the solid-liquid solution is difficult. This limits the industrialization of nano-silver. Moreover, the purity of the product is difficult to ensure. In addition, the waste generated in the production process may pollute the environment.

Still further, the nano-silver powder extracted from the solution easily forms agglomerates, which are difficult to disperse again. This becomes a technical barrier to the application of nano-silver in various industries.

Generally, the physical preparation method of nano-silver according to known preparation methods is only suitable for laboratory operation, and needs to be protected by an inert gas such as argon gas or helium gas. In the absence of the protection from an inert gas, silver can be easily oxidized to form silver oxide, which undermines its bactericidal effect. Moreover, the particle size is difficult to have a uniform distribution. Only when heated to a temperature of 300° C. can the oxygen element in the silver oxide be completely removed and the silver reduced to metal silver. However, the foregoing process may form large particle agglomerates, thereby the bactericidal performance thereof is greatly reduced.

### SUMMARY

The present disclosure describes methods of preparing a nano-powder that overcomes various challenges, drawbacks, and barriers associated with known nano-power preparation methods and comprises preparing a material, gasifying the material, condensing the material, and collecting the condensed material for further treatment and/or use. The present disclosure also describes systems and methods of utilizing a nano-powder such as a nano-powder prepared according to the methods described herein.

A method of preparing a silver alloy composite nanomaterial according to one embodiment of the present disclosure comprises: preparing a composite metal rod by combining silver with one or more of copper, zinc, magnesium, aluminum, and titanium; evaporating a tip of the composite metal rod by using the composite metal rod as an anode conductor of a direct current power supply and forming an electric arc between the anode conductor and a cathode, yielding a gaseous alloy; and cooling the gaseous alloy by subjecting the gaseous alloy to a gas, for example air, flowing at about 0.5 to about 1.5 times the speed of sound, causing the gaseous alloy to condense and yielding a cooled silver alloy composite nanomaterial.

Aspects of the foregoing method may include at least one of the following: further comprising collecting the cooled silver alloy composite nanomaterial with a powder collector; wherein silver accounts for about 40% to about 80% of the composite metal rod by weight; wherein preparing the composite metal rod further comprises: weaving a silver wire with a metal wire of one or more of copper, zinc, magnesium, aluminum, and titanium to yield a mixed metal wire, and cold rolling the mixed metal wire to yield the composite metal rod; wherein at least one of the silver wire and the metal wire of one or more of copper, zinc, magnesium, aluminum, and titanium has a diameter of about 0.4 to about 1.0 mm, and the composite metal rod has a diameter of about 4 to about 6 mm; wherein a temperature of the arc formed between the anode conductor and the cathode is at least about 5000° C.; wherein a particle size of the cooled silver alloy composite nanomaterial is from about 10 nm to about 30 nm; wherein the direct current power supply has a voltage of about 30 to about 40 V and a current of about 900 to about 1100 A; wherein the air is flowing at about 1 to about 1.2 times the speed of sound; further comprising applying the cooled silver alloy composite nanomaterial to one of a textile product and a fabric product; further comprising coating a hard surface of an article of manufacture in the cooled silver alloy composite nanomaterial; and/or wherein the coating the hard surface of the article of manufacture in the cooled silver alloy composite nanomaterial comprises mixing the cooled silver alloy composite nanomaterial with a bonding agent.

An article of clothing according to another embodiment of the present disclosure comprises a fabric permeated with a silver alloy composite nanomaterial.

Aspects of the foregoing article of clothing may include: wherein the silver alloy composite nanomaterial comprises an alloy of silver and at least one of copper oxide, zinc oxide, magnesium oxide, aluminum oxide, or titanium oxide; wherein a particle size of particles of the silver alloy composite nanomaterial is from about 10 nm to about 30 nm; and/or wherein silver accounts for about 40% to about 80% by weight of the silver alloy composite nanomaterial.

An article of manufacture according to another embodiment of the present disclosure comprises: at least one surface coated with a silver alloy composite nanomaterial, wherein the silver alloy composite nanomaterial comprises an alloy of silver and at least one of copper oxide, zinc oxide, magnesium oxide, aluminum oxide, or titanium oxide, and further wherein silver accounts for about 40% to about 80% of the by weight of the silver alloy composite nanomaterial.

Aspects of the foregoing article of manufacture may include: wherein a particle size of particles of the silver alloy composite nanomaterial is from about 10 nm to about 30 nm; wherein the silver alloy composite nanomaterial is secured to the at least one surface with a bonding agent; and/or wherein the article of manufacture is intended to be worn on a human body.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Zₒ, the phrase is intended to refer to a single element selected from X, Y, and Z, a combination of elements selected from the same class (e.g., X₁ and X₂) as well as a combination of elements selected from two or more classes (e.g., Y₁ and Zₒ).

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

It should be understood that every maximum numerical limitation given throughout this disclosure is deemed to include each and every lower numerical limitation as an alternative, as if such lower numerical limitations were expressly written herein. Every minimum numerical limitation given throughout this disclosure is deemed to include each and every higher numerical limitation as an alternative, as if such higher numerical limitations were expressly written herein. Every numerical range given throughout this disclosure is deemed to include each and every narrower numerical range that falls within such broader numerical range, as if such narrower numerical ranges were all expressly written herein.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

### BRIEF DESCRIPTION OF THE DRAWINGS

The accompanying drawings are incorporated into and form a part of the specification to illustrate several examples of the present disclosure. The drawings are not to be construed as limiting the disclosure to only the illustrated and described examples.

FIG. 1 is a flowchart of a method according to an embodiment of the present disclosure;

FIG. 2 is a flowchart of another method according to an embodiment of the present disclosure;

FIG. 3 is a scanning electron micrograph of a first example described in the present disclosure;

FIG. 4 is a transmission electron micrograph of a first example described in the present disclosure.

FIG. 5 is a scanning electron micrograph of a second example described in the present disclosure.

FIG. 6 is a transmission electron micrograph of a second example described in the present disclosure.

FIG. 7 is a scanning electron micrograph of a third example described in the present disclosure.

### DETAILED DESCRIPTION

At present, most nano-silver is produced by chemical methods. However, nano-silver produced by such methods is present in the reaction solution, and separation of the solid nano-silver from the liquid in the solid-liquid solution is difficult. This limits the industrialization of nano-silver. Moreover, the purity of the product is difficult to ensure. In addition, the waste generated in the production process may pollute the environment.

Still further, the nano-silver powder extracted from the solution easily forms agglomerates, which are difficult to disperse again. This becomes a technical barrier to the application of nano-silver in various industries.

Generally, the physical preparation method of nano-silver according to known preparation methods is only suitable for laboratory operation, and needs to be protected by an inert gas such as argon gas or helium gas. In the absence of the protection from an inert gas, silver can be easily oxidized to form silver oxide, which undermines its bactericidal effect. Moreover, the particle size is difficult to have a uniform distribution. Only when heated to a temperature of 300° C. can the oxygen element in the silver oxide be completely removed and the silver reduced to metal silver. However, the foregoing process may form large particle agglomerates, thereby the bactericidal performance thereof is greatly reduced.

In view of the above technical problems, the present disclosure describes methods of preparing a silver alloy composite nanomaterial. The production process is simple and controllable, and the energy consumption is low, thereby facilitating large scale production. In addition, the method is environmentally friendly. Compared with the simple nano-silver in the prior art, the silver alloy composite nanomaterial of the present disclosure does not easily agglomerate and thus maintains its particle size. Further the bactericidal performance of the composite nano-powder is more stable and reliable.

Compared with the prior art, the beneficial effects of embodiments of the present disclosure are as follows:

In embodiments of the present disclosure, the nano-material is produced based on the physical principles of gasification and condensation, and no chemical raw materials such as acid and alkali are needed, and no pollutants such as waste water, waste gas and waste solid are generated.

In embodiments of the present disclosure, through adjusting the ratio of raw materials in the composition, as well as adjusting and controlling the operating parameters such as voltage, current, gas flow, temperature, etc., the production process of the present disclosure is simple and controllable, and the energy consumption is low, thereby facilitating large scale productions. Moreover, the product is clean and the product quality is guaranteed.

In embodiments of the present disclosure, in the production process without inert gas protection, the physical properties of copper, zinc, magnesium, aluminum and/or titanium metal are fully utilized, which effectively prevents atomic agglomeration and oxidation of metal silver. The particles of the composite nano-powder are only about 10 nm to about 30 nm in size, and the size of the metal silver may be even smaller. Therefore, compared with pure nano-silver, the product of the present disclosure does not easily to agglomerate or grow in particle size, and the bactericidal performance of the composite nano-powder is more stable and reliable.

In embodiments of the present disclosure, the prepared composite nano-powder combines the characteristics of at least one metal oxide such as copper oxide, zinc oxide, magnesium oxide, aluminum oxide, titanium dioxide, etc., and is more convenient in the application of specific products in the fields of textiles, coatings, ceramics, medicine, metal processing, and so on.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, the present disclosure may use examples to illustrate one or more aspects thereof. Unless explicitly stated otherwise, the use or listing of one or more examples (which may be denoted by “for example,” “by way of example,” “e.g.,” “such as,” or similar language) is not intended to and does not limit the scope of the present disclosure.

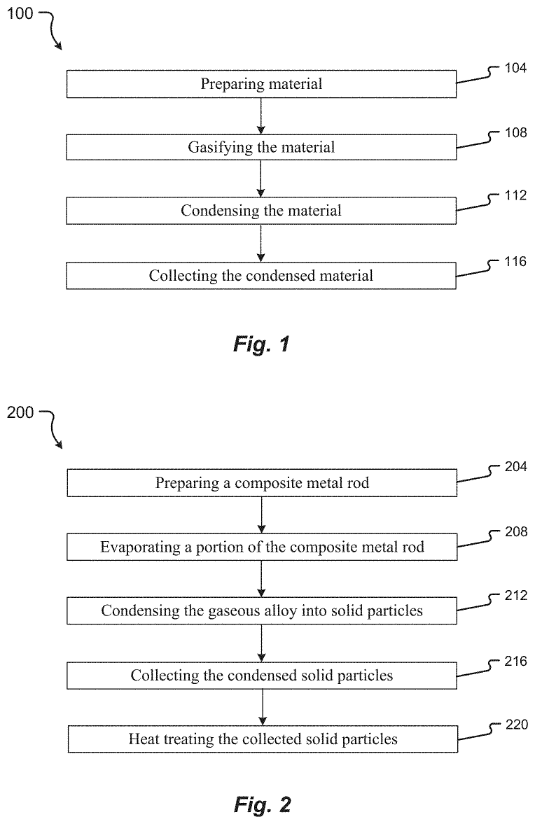

Referring first to FIG. 1, a method 100 for preparing a nano-powder according to embodiments of the present disclosure comprises preparing material (step 104); gasifying the material (step 108); condensing the material (step 112); and collecting the condensed material (step 116).

With respect to preparing the material (step 104), the material may be, for example, a silver alloy in a solid state. Embodiments of the present disclosure may utilize a silver alloy comprising one or more of copper, zinc, magnesium, aluminum, or titanium. Preparing the material may comprise, for example, combining raw materials (e.g., wires of the constituent metals of the silver alloy) into a composite metal rod. In the composite metal rod, silver may account for about 40% to about 80% of the rod by weight or mass. Further, the weight or mass percentage of copper, zinc, magnesium, aluminum, or titanium may be from about 20% to about 60%. In some embodiments, less than about one weight or mass percent of incidental materials can be included in the composite. Preparing the material may further comprise weaving a silver wire with a metal wire of at least one of copper, zinc, magnesium, aluminum, and titanium into a mixed metal wire, and cold rolling to form the composite metal rod. The metal wire of the silver, copper, zinc, magnesium, aluminum, and/or titanium may have a diameter of about 0.4 to about 1.0 mm, and the composite metal rod may have a diameter of about 4 to about 6 mm.

Gasifying the material (step 108) may comprise, for example, heating the composite alloy until the composite alloy transitions to a gaseous state. This may be accomplished, for example, by forming an electric arc with a cathode using a composite metal rod as an anode conductor of a direct current power source to cause gasification and evaporation of a metal rod tip end of the anode conductor, so as to generate a gaseous metal atomic group, such that silver atoms are sufficiently mixed with atoms of at least one of copper, zinc, magnesium, aluminum and titanium atoms to form a gaseous alloy. The temperature of the arc formed by the anode conductor and the cathode may be about 5000° C. or higher. In some embodiments, the temperature of the arc formed by the anode conductor and the cathode may be between about 5000° C. and about 10,000° C. The direct current power supply used to form the arc may have a voltage of about 30 to about 40 volts, and a current of about 900 to about 1100 amps.

Condensing the material (step 112) may comprise, for example, cooling the gaseous composite alloy until the gaseous composite alloy condenses into a solid state, in which solid state the gaseous composite alloy may comprise a nano-powder comprising nanoparticles. Such cooling may be accomplished, for example, by applying an air flow traveling at about 0.5 to about 1.5 times the speed of sound to the gaseous alloy. In some embodiments, the air flow may be directed on the gaseous alloy at the same time as the metal gasification. Use of such a high speed air flow shortens the transition time period from the gaseous state to the solid state, and prevents the formation of a core-shell structure of the component materials as a result of the difference in their respective melting points. In addition, a quick cooling process can help to reduce the oxidation of silver atoms. On the other hand, during the cooling process, copper, zinc, magnesium, aluminum and/or titanium metal atoms associate with the oxygen atoms in the air more easily than do the silver atoms, and form the respective metal oxide (e.g., copper oxide, zinc oxide, magnesium oxide, aluminum oxide or titanium dioxide). The silver atom, however, returns to solid elemental silver.

Still further, introducing a large amount of cooling air into the system causes the hydrogen and oxygen atoms in the air to collide with the gaseous metal atoms of the silver and of the copper, zinc, magnesium, aluminum, and/or titanium, such that the same metal atoms cannot aggregate significantly, thereby returning from the gaseous state to a solid state to form composite particles having a particle size of about 10 nm to about 30 nm. This helps to ensure that the metal silver therein exists in a nanoscale form.

Collecting the condensed material (step 116) may comprise collecting the solid state nanoparticles, which may then be subjected to further processing such as heat treating. The finally obtained composite nano-powder is not a simple mixture of nano-silver particles with metal oxide particles formed of copper oxide, zinc oxide, magnesium oxide, aluminum oxide and/or titanium dioxide. Rather, the resulting composite nano-powder is a brand new material in which silver and the metal oxide (whether copper oxide, zinc oxide, magnesium oxide, aluminum oxide and/or titanium dioxide) are tightly bonded at the atomic level, and these components cannot be separated individually.

Referring now to FIG. 2, a method 200 for preparing a silver composite nano-powder according to embodiments of the present disclosure comprises preparing a composite metal rod (step 204). The composite metal rod may be prepared, for example, from a first silver wire and a second wire formed of a metal to be alloyed with the silver. The first and second wires may be combined in any known manner to achieve a composite metal rod with a desired mass percentage of silver. In some embodiments, for example, the first and second wires may be woven together into a mixed metal wire, and then cold rolled to form a composite metal rod.

The method 200 comprises evaporating a portion of the composite metal rod (step 208). The evaporating causes the portion of the composite metal rod to transition from a solid state into a gaseous state. In some embodiments, the evaporating is accomplished by using the composite metal rod as an anode conductor. Any known method or operation for evaporating metals may alternatively be used to evaporate a portion of the composite metal rod.

The gaseous alloy is condensed into solid particles (step 212). In some embodiments, the gaseous alloy is quickly removed from the high temperature region of the gasification process and rapidly cooled to or beyond the point of condensation. The evaporating and condensing steps may occur at the same time or in immediate succession, so that newly evaporated gaseous alloy is continuously being condensed.

The condensed solid particles are collected (step 216). In some embodiments, for example, the gas-solid separation resulting from the evaporating step 208 and the condensing step 212 is passed through a powder collector, so as to obtain a composite nano-powder.

The composite nano-powder is subjected to heat treatment (step 220). The heat treatment may be selected to prevent the oxidization of silver in the composite nano-powder. In some embodiments, the heat treatment can be at a temperature between about 280° C. and about 400° C., in some embodiments about 300° C.

Two examples utilizing the method 200 will now be described. In a first example, a composite metal rod was formed of a silver wire having a diameter of about 0.5 mm and a purity of about 99.9%, and a copper wire having a diameter of about 0.5 mm and a purity of about 99.9%. The silver wire accounted for about 70% of the total mass of the composite metal rod while the copper wire accounted for about 30% of the total mass of the composite metal rod. The silver wire and the copper wire were woven into a mixed metal wire having a diameter of about 8 mm, and then cold rolled to form a metal rod with a diameter of about 5 mm.

The composite metal rod was then used as an anode conductor and subjected to a direct current voltage of about 36 volts, a current of about 1050 amps, an arc length of about 30 mm, and a temperature of about 5000° C. or higher, resulting in gasification of the metal alloy of the composite metal rod.

While the metal gasification was occurring, the gaseous alloy was removed from the high temperature region of the gasification process by a flow of air traveling at approximately the speed of sound. This resulted in rapid cooling as well as condensation of the metal alloy, so as to form composite particles having a particle size of about 10 nm to about 30 nm when the metal returned from the gaseous state to a solid state.

The gas-solid separation was carried through a powder collector, so as to obtain a composite nano-powder of silver copper oxide alloy, which was then subjected to a heat treatment at about 300° C. (between about 280° C. and about 400° C.). The color of the powder did not change after the powder was heated, so the silver content in the powder did not oxidize.

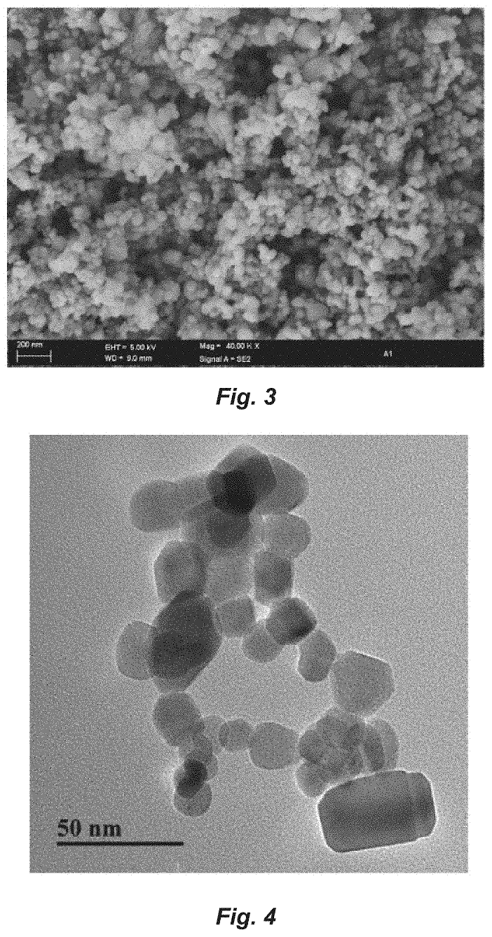

FIGS. 3 and 4 comprise images obtained by a scanning electron microscope and transmission electron microscope of the resulting silver copper oxide alloy nano-powder obtained as described above. The obtained particles are uniform and the agglomeration problem is minor. The transmission electron micrograph provided in FIG. 4 shows that the particle size of the powder is from about 10 nm to about 30 nm. If the metallic silver and other oxides in the powder are separate particles, then the composite nanoparticle of the silver copper oxide alloy will grow larger when heated at about 300° C. to form hard agglomeration. However, the powder particles shown in the electron micrograph are heat treated and yet do not have such large hard agglomerated particles.

The composite nano-powder of silver copper oxide alloy obtained as described above was subjected to an antibacterial test with textile (knitted cloth), and achieved the following antibacterial rates: about 99.99% for Escherichia coli, about 99.99% for Staphylococcus aureus, and about 99.92% for Candida albicans. By conversion, the bactericidal rates of the composite nano-powder are about 95.71% for Escherichia coli, about 99.77% for Staphylococcus aureus, and about 97.17% for Candida albicans. Not only do these bactericidal rates meet the AAA standard for antibacterial textiles, but also in actual use, the textiles can be used for in some embodiments, greater than 0 days and less than about seven days, in some embodiments about seven days, and in still some embodiments at least about seven days, continuously without change, and remain odorless.

In a second example of using the method 200 to obtain a silver composite nano-powder, a composite metal rod was formed of a silver wire having a diameter of about 0.5 mm and a purity of about 99.9%, and a zinc wire having a diameter of about 0.5 mm and a purity of about 99.9%. The silver wire accounted for about 80% of the total mass of the composite metal rod while the zinc wire accounted for about 20% of the total mass of the composite metal rod. The silver wire and the zinc wire were woven into a mixed metal wire having a diameter of about 8 mm, and then cold rolled to a metal rod with a diameter of about 5 mm.

The metal rod of silver and zinc was then used as an anode conductor under a DC voltage of about 32 volts, a current of about 980 amps, an arc length is about 28 mm, and a temperature of about 5000° C. or higher, resulting in gasification of the silver-zinc alloy of the composite metal rod.

At the same time as the metal gasification, the gaseous alloy was removed from the high temperature region by an air flow of about 1.2 time the speed of sound for rapid cooling so as to form a composite particle of about 10 nm to about 30 nm when the metal returned from the gaseous state to a solid state.

The gas-solid separation was passed through a powder collector, so as to obtain a composite nano-powder of silver zinc oxide alloy. This silver zinc oxide alloy nano-powder was then subjected to a heat treatment at about 300° C. (between about 280° C. and about 400° C.). The color of the powder did not change after the powder was heated, so the silver content in the powder did not oxidize.

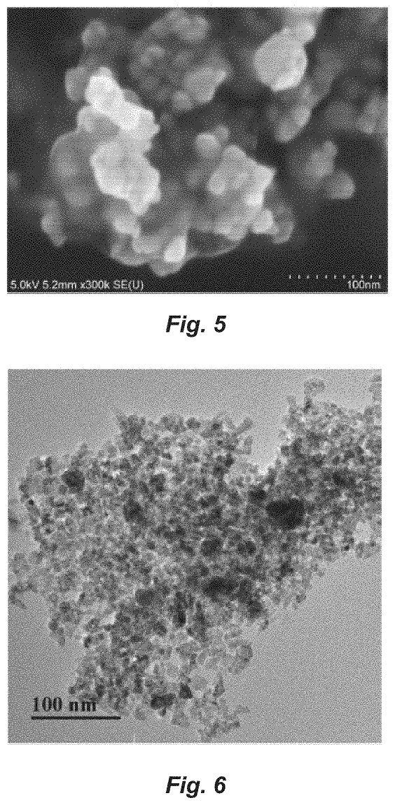

FIGS. 5 and 6 comprise images obtained by a scanning electron microscope and transmission electron microscope of the resulting silver zinc oxide alloy nano-powder obtained as described above. As in the first example, the obtained particles are uniform and the agglomeration problem is minor.

The silver zinc oxide alloy obtained in the present example was next subjected to antibacterial test as a coating, and achieved the following antibacterial rates: about 99.99% for Escherichia coli and about 99.99% for Staphylococcus aureus. The silver zinc oxide alloy was coated on the inner liner of a refrigerator, and the refrigerator was put into normal use for about 6 months. At the conclusion of the 6 months, no bacteria was detected on the coating, and the inside of the refrigerator was completely odorless.

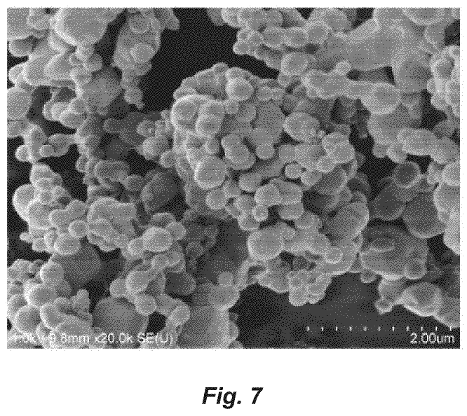

A third example is now described for purposes of comparison with the first example. In the third example, substantially pure silver was evaporated in the same manner as described in the first example. However, in the condensing step, the cooling air flow rate was less than about 0.3 times the speed of sound. The obtained mixture of metal silver and silver oxide was then heated to a temperature of about 300° C. to obtain a nano-silver powder. FIG. 7 shows the scanning electron micrograph of this resulting powder. The particles in FIG. 7 are significantly larger than the silver copper oxide alloy particles and the silver zinc oxide alloy particles in the first and second examples, and are accompanied by large agglomerates.

The mixture of silver metal and silver oxide obtained in this comparative example was then used for antibacterial tests with textiles (socks), and demonstrated antibacterial rates of about 88.24% for Escherichia coli, about 98.43% for Staphylococcus aureus, and about 96.84% for Candida albicans. The bactericidal rates were: E. coli about 0%, Staphylococcus aureus about 63.33%, and Candida albicans about 40.00%. Although the nano-powder of this third example met the AAA standard for antibacterial textiles, the nano-powder did not prevent odor generation.

Comparing the first and third examples, the silver alloy composite nanomaterial obtained in the first example had better antibacterial performance and less agglomeration than the pure nano-silver obtained in the third example.

The silver alloy nanomaterial obtained using the methods 100 and/or 200 may be applied on or to a variety of textiles, fabrics, and surfaces where sterility is important and not always easy to maintain, such that a passive (e.g., inorganic) antibacterial/bactericidal substance may be useful. For example and as described above, silver alloy nanomaterials may be applied to textiles and fabrics, including to articles of clothing made of textiles and fabrics. The use of silver alloy nanomaterials may be particularly beneficial on articles of clothing that may be expected to exposed to sweat or to become odorous, including socks, underwear, shoe liners, athletic and/or workout clothing (including shirts, shorts, pants, jackets, coats, headbands, wristbands, sweatbands, hats, jock straps, sports bras, sports uniforms, and the like) and any other such articles of clothing. Fabrics and textiles used in bath and bedding products, such as bathroom and other floor mats, towels, linens, sheets, blankets, bed coverings, pillowcases, pillows, mattress pads, mattresses, and the like may also benefit from application of silver alloy nanomaterials thereto. Silver alloy nanomaterials may also be beneficially applied to equipment (including both fabric/textile portions of such equipment and non-fabric/non-textile surfaces of such equipment) intended to be worn on the body that may be expected to be exposed to sweat and/or to become odorous, including sports equipment (e.g., football pads, hockey pads, helmets, facemasks, shin guards, and the like) and security/protective equipment (e.g., police and/or military tactical vests, helmets, riot gear). Further application of silver alloy nanomaterials may be made beneficially in connection with fabrics, textiles, and equipment in the medical field, including hospital linens, sheets, bed coverings, towels, surgical gauze, bandages, sponges, diapers, chair cushions and coverings, and other soft medical materials; surfaces and handles of operating tables, examination tables, beds, and other surfaces that need to be sterile or would benefit from being sterile. Any fabric, textile, or surface that needs to be sterile or would benefit from being sterile, or that may be expected to become odorous, may benefit from application of silver alloy nanomaterials thereto.

Silver alloy nanomaterials may be applied to a textile or fabric in a variety of ways. For example, the textile or fabric may be permeated with the silver alloy nanomaterials, or the silver alloy nanomaterial may be sprayed thereon, whether in a dry or wet solution. The silver alloy nanomaterials may also be mixed with a bonding agent prior to application thereof to a textile or fabric. Similarly, silver alloy nanomaterials may be mixed with or applied on top of a bonding agent when applied to hard surfaces such as refrigerator surfaces, operating tables, and the like.

A number of variations and modifications of the disclosure can be used. It would be possible to provide for some features of the disclosure without providing others.

Ranges have been discussed and used within the forgoing description. One skilled in the art would understand that any sub-range within the stated range would be suitable, as would any number or value within the broad range, without deviating from the invention. Additionally, where the meaning of the term “about” as used herein would not otherwise be apparent to one of ordinary skill in the art, the term “about” should be interpreted as meaning within plus or minus five percent of the stated value.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and/or reducing cost of implementation.

The foregoing discussion has been presented for purposes of illustration and description. The foregoing is not intended to limit the disclosure to the form or forms disclosed herein. In the foregoing Detailed Description, for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

Any of the steps, functions, and operations discussed herein can be performed continuously and automatically.

What is claimed is:

1. A textile applied with a silver alloy composite nanomaterial, wherein the silver alloy composite nanomaterial comprises an alloy of silver and one of a copper oxide, a zinc oxide, a magnesium oxide, an aluminum oxide, or a titanium oxide.

2. The textile of claim 1, wherein the textile is at least one of a bath and bedding product, an article of clothing, equipment intended to be worn on a human body, or a medical field product.

3. The textile of claim 1, wherein a particle size of particles of the silver alloy composite nanomaterial is from 10 nm to 30 nm.

4. The textile of claim 1, wherein the silver accounts for 40% to 80% by weight of the silver alloy composite nanomaterial.

5. The textile of claim 1, wherein the silver alloy composite nanomaterial is applied by at least one of permeation or spraying.

6. The textile of claim 5, wherein the silver alloy composite nanomaterial is applied by spraying, and wherein the textile includes a coat of bonding agent sprayed onto the textile prior to spraying the silver alloy composite nanomaterial onto the textile.

7. The textile of claim 5, wherein the silver alloy composite nanomaterial is applied by spraying and the silver alloy composite nanomaterial is sprayed as at least one of a dry solution or a wet solution.

8. The textile of claim 1, wherein, the silver alloy includes a bonding agent mixed with the silver alloy.

9. An article of clothing comprising a fabric permeated with a silver alloy composite nanomaterial, wherein the silver alloy composite nanomaterial comprises an alloy of silver and one of a copper oxide, a zinc oxide, a magnesium oxide, an aluminum oxide, or a titanium oxide.

10. The article of clothing of claim 9, wherein a particle size of particles of the silver alloy composite nanomaterial is from 10 nm to 30 nm.

11. The article of clothing of claim 9, wherein the silver accounts for 40% to 80% by weight of the silver alloy composite nanomaterial.

12. An article of manufacture having at least one surface coated with a silver alloy composite nanomaterial, wherein the silver alloy composite nanomaterial comprises an alloy of silver and at least one of a copper oxide, a zinc oxide, a magnesium oxide, an aluminum oxide, or a titanium oxide.

13. The article of manufacture of claim 12, wherein a particle size of particles of the silver alloy composite nanomaterial is from 10 nm to 30 nm.

14. The article of manufacture of claim 12, and wherein the silver comprises 40% to 80% of the by weight of the silver alloy composite nanomaterial

15. The article of manufacture of claim 12, wherein the article of manufacture is intended to be worn on a human body.

16. The article of manufacture of claim 12, wherein the silver alloy composite nanomaterial is secured to the at least one surface with a bonding agent.

17. The article of manufacture of claim 16, wherein the silver alloy is mixed with the bonding agent.

18. The article of manufacture of claim 16, wherein the at least one surface includes a coat of the bonding agent underneath the coat of silver alloy.

19. The article of manufacture of claim 12, wherein the at least one surface is a solid surface.

20. The article of manufacture of claim 12, wherein the article of manufacture is equipment in the medical field or equipment intended to be worn on a human body.
